(19) United States
(12) Patent Application Publication
(10) Pub. No.: US 2026/0305724 A1
(43) Pub. Date: Oct. 8, 2026

(54) An Aerosol Generating Device and a Method for Making a Light Diffuser for an Aerosol Generating Device

(71) Applicant: JT International SA, Geneva (CH)

(72) Inventor: Juraj Lehocky, Bratislava (SK)

(73) Assignee: JT International SA, Geneva (CH)

(21) Appl. No.: 19/482,060

(22) PCT Filed: May 3, 2024
(86) PCT No.: PCT/EP2024/062287

§ 371 Date: Nov. 6, 2025

(30) Foreign Application Priority Data
May 11, 2023 (EP) 23172937.7

(51) Int. Cl. A24F 40/60; A24F 40/70; B33Y 80/00; F21V 3/04; F21V 33/00; F21Y 103/10; F21Y 115/10

(52) U.S. Cl. CPC A24F 40/60; A24F 40/70; B33Y 80/00; F21V 3/049; F21V 33/0004; F21Y 2103/10; F21Y 2115/10

(57) ABSTRACT

An aerosol generating device includes a body having a non-opaque window, an array of light sources located inside the body, and light diffuser disposed between the array of light sources and the non-opaque window. The light diffuser has a first face facing the array of light sources and having a pattern of a plurality of dome-shaped recesses and a second face opposed to the first face and directly or indirectly visible through the non-opaque window.

### TECHNICAL FIELD

An aerosol generating device is described. The aerosol generating device is configured to receive a consumable article to be heated, for example resistively or inductively, to generate an inhalable aerosol. The consumable article may comprise an aerosol precursor material being any one of a liquid, a gel, a solid, and comprising tobacco or not. A method for making a light diffuser of the aerosol generating device is also described.

### BACKGROUND ART

Aerosol generating devices are an alternative to conventional cigarettes. Instead of generating inhalable smoke by combustion of an aerosol generation material such as tobacco, they generate an aerosol which can be inhaled by a user, heating, without combusting, an aerosol precursor material comprising an aerosol former component. An aerosol generating device is a hand-held inhaler system having a housing to accommodate working components. The housing of the aerosol generating device may be elongated in a shape for a user to hold. It typically comprises a mouthpiece section, a housing for the consumable article, a vaporizer, a heating unit and a power supply unit, such as a battery. Vaporization is achieved when the heating unit heats the consumable article to form an aerosol that is inhalable through the mouthpiece section.

The power supply unit may comprise a battery and electronic control circuitry, for example arranged at least partially on a printed circuit board (PCB), as well as sensors, wireless communication chips or modules and control switches where appropriate. A receptacle, for example a USB-C receptacle, is provided in the aerosol generating device. The receptacle is configured to mechanically and electrically connect to a plug so that it receives power to recharge the battery from an external power source by means of the plug. Additionally or alternatively, a wireless charging coil may be provided in the aerosol generating device.

The electrical power consumption, the device health or any other useful information may be provided through an illuminated status indicator.

There is a need for an aerosol generating device having an improved illuminated status indicator.

### SUMMARY

This disclosure improves the situation.

It is proposed an aerosol generating device comprising
a body having a non-opaque window,
an array of light sources located inside the body,
a light diffuser disposed between the array of light sources and the non-opaque window and having
   a first face facing the array of light sources and comprising a pattern of a plurality of dome-shaped recesses and
   a second face opposed to the first face and directly or indirectly visible through the non-opaque window.

The presence of the light diffuser with such a special pattern allows to achieve a homogenous bar visible by a user. This means that the array of light sources looks like an uninterrupted bar, the light sources being not individually visible. The pattern of dome-shaped recesses has wide diffusion properties. The pattern of dome-shaped recesses may disrupt the light rays from the light sources of the array.

This user interface can be implemented in a wide range of aerosol generating devices. It is possible to display multiple pieces of information through the array of light sources.

By “dome-shaped recesses”, it is to be understood that the first face comprises reliefs that are concave towards the array of light sources, said reliefs having a shape of domes, i.e. curved surfaces, for example spherical surfaces.

The following features can be optionally implemented, separately or in combination one with the others:

The light diffuser may be configured so that at least one dome-shaped recess, preferably at least two dome-shaped recesses, of the plurality of dome-shaped recesses is(are) on the way of a straight path of light of one light source of the array of light sources.

This ensures that the path of light goes through at least one, preferably at least two, dome-shaped recesses, so that the effect of light diffusion may be fully obtained.

The light diffuser may be placed directly behind the array of light sources with the first face of the light diffuser facing the light sources. This means that the light sources are touching or almost touching part of the light diffuser. This will help to break the light rays and unite them on the opposite, second, face (or side) of the light diffuser.

At least part of the dome-shaped recesses, preferably each dome-shaped recess, may have a spherical shape. At least part of the dome-shaped recesses are preferably identical to one another. The dome-shaped recesses may all be identical to one another. The dome-shaped recesses may have a symmetric shape. In case the dome-shaped recesses have a symmetric and spherical shape, there may be a point that is in the center of the dome-shaped recess and that is the most distant point of the dome-shaped recess from the light source.

At least two dome-shaped recesses of the plurality of dome-shaped recesses may be side by side in contact with one another. They may have an edge in common.

Said pattern may comprise a plurality of parallel ranges of dome-shaped recesses, the ranges being oriented perpendicularly to a longitudinal axis of the non-opaque window.

In an example, the light diffuser comprises thirty-four parallel ranges, each range extending perpendicularly to the longitudinal axis of the non-opaque window, each range having six dome-shaped recesses. The number of ranges and dome-shaped recesses may be different without departing from the scope of the disclosure.

At least one dome-shaped recess of the pattern, preferably each dome-shaped recess, may be part of a virtual sphere having a diameter equal to about 1 mm.

The width of a dome-shaped recess, in particular within a range, may be equal to 0.55 mm. The length of a dome-shaped recess, in particular in a range, may be equal to 0.7 mm. The front peripheral shape of a dome-shaped recess, especially within a range, having other dome-shaped recesses all around its periphery may be rectangular. This peripheral shape of one dome-shaped recess may be delimited by the peripheral shapes of adjacent dome-shaped recesses, except at the end of a range, for example.

Several dome-shaped recesses may be placed over each single light source. This breaks the rays multiple times and diffuses back on the second face which is the rear face.

The second face of the light diffuser is for example substantially flat, notably with no relief thereon. In such a case, the flat surface of the second face unites the rays that were disrupted by the pattern of dome-shaped recesses, thereby creating the perception of a homogeneous light bar.

In another example, the second face of the light diffuser comprises at least one depression, notably a plurality of depressions. Such a plurality of depressions may be preferably made of a plurality of parallel grooves extending perpendicularly to a longitudinal axis of the non-opaque window. The depressions, for example the grooves, are preferably concave towards the non-opaque window.

The light diffuser may be made of a non-transparent and non-opaque, preferably white, polymer material chosen in the group consisting of a tough PLA (polylactic acid), ABS (Acrylonitrile Butadiene Styrene), PA (Polyamide), PMMA (Acryl or Polymethylmethacrylate), PC (Polycarbonate), POM (polyoxymethelen), and ASA (Acrylonitrile styrene acrylate).

The light diffuser is preferably made by 3D printing, preferably on a high-resolution 3D printer. In a variant, it is injection moulded.

At least one of the first and second faces of the light diffuser may be sanded.

The light diffuser may be inserted into an inner tray of the aerosol generating device between the non-opaque window and the array of light sources. The light sources of the array are preferably fixed to a printed circuit board of the aerosol generating device.

The light diffuser may be part of an inner tray of the aerosol generating device. In such case, the postprocessing may be reduced and the positioning issue may be already solved.

The array of light sources may be a linear array. In such case, the light sources of the array may be spaced apart from each other. The array of light sources may comprise eight light sources, preferably eight aligned light sources. The distance between two adjacent light sources may be comprised between 1 mm and 6 mm.

The light sources of the array are preferably light emitted diodes (LED).

The emitting angle of at least one light source of the array of light sources may be equal to 120°.

The aerosol generating device may comprise a light sources controller, for example a LED controller. Such a controller may be able to operate a maximum number of light sources, this maximum number being for example equal to eight. The number of light sources of the array may be lower than eight without departing from the scope of the disclosure. In such case, the power consumption of the aerosol generating device may be reduced. Such a LED controller may be provided as an integrated circuit.

The device may comprise a glass outwardly covering the light diffuser and extending in the non-opaque window. In such case, the second face of the light diffuser may be indirectly visible through the non-opaque window. In another example, the non-opaque window does not comprise any glass. In the latter case, the second face of the light diffuser may be directly visible through the non-opaque window.

In another aspect, in combination with the above, it is proposed a method for making a light diffuser for an aerosol generating device as described above, comprising 3D-printing the light diffuser, preferably with a high-resolution 3D printer, from a non-transparent, preferably white, polymer material, for example chosen in the group consisting of a tough PLA, ABS, acrylic glass, the 3D-printing comprising forming a plurality of dome-shaped recesses in the first face of the light diffuser.

This method provides a light diffuser that can be included in an aerosol generating device as described above, either by being inserted into an inner tray of the aerosol generating device between the non-opaque window and the array of light sources or by being part of an inner tray of the aerosol generating device.

The light diffuser made by this method produces the desired effect, i.e. helps producing a homogeneous light effect visible by a user through the non-opaque window, the light effect coming from the light sources array passing through the light diffuser.

The method may comprise creating a 3D model of the light diffuser before making it by 3D printing.

### BRIEF DESCRIPTION OF DRAWINGS

Other features, details and advantages will be shown in the following detailed description and on the figures, on which:

FIG. 1 is a schematic view in perspective of an aerosol generating device according to an example, in a closed position.

FIG. 2 is a schematic side view in longitudinal section of a portion of the aerosol generating device of FIG. 1.

FIG. 3 is a schematic view similar to the one of FIG. 2 after switching on the light sources.

FIG. 4 is a view similar to the one of FIG. 3 of an example without the light diffuser, not comprised in the present disclosure.

FIG. 5 is an isolated schematic front view of a light diffuser according to an example.

FIG. 6 is a schematic side view in longitudinal section of the light diffuser of FIG. 5.

FIG. 7 is a schematic side view of the light diffuser of FIG. 5 seen from the bottom thereof.

FIG. 8 is an isolated schematic side view of a 3D model of the light diffuser created before a 3D printing process according to an example.

FIG. 9 is an isolated schematic view in perspective of a light diffuser according to another example.

FIG. 10 is a schematic side view in longitudinal section of the light diffuser of FIG. 9.

FIG. 11 is a schematic view in perspective of an example of an aerosol generating device, in an opened position, the view showing a printed circuit board housed in the aerosol generating device.

FIG. 12 is an isolated schematic view in perspective of part of an inner tray of the aerosol generating device of FIG. 11.

FIG. 13 is an isolated schematic view in perspective of part of an inner tray of the aerosol generating device according to an example.

FIG. 14 is a schematic view in perspective of an example of an aerosol generating device comprising the inner tray of FIG. 13, the aerosol generating device being shown in an opened position.

### DESCRIPTION OF EMBODIMENTS

Aspects set forth below represent the necessary information to enable those skilled in the art to practice the disclosure. The same references correspond to the same elements on different drawings. These elements may be described on only one or more figures, but they apply to all figures except for mention to the contrary.

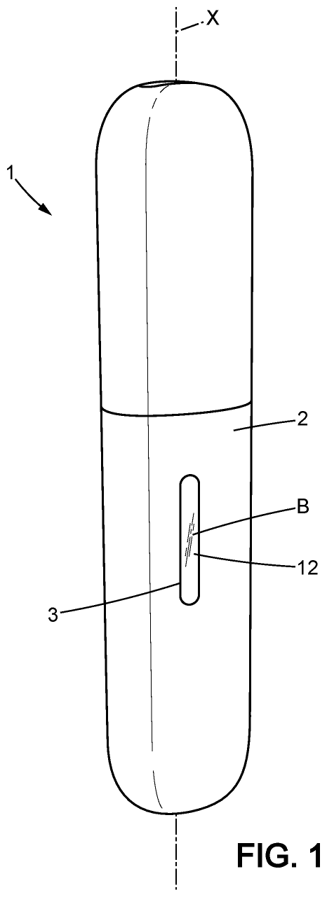

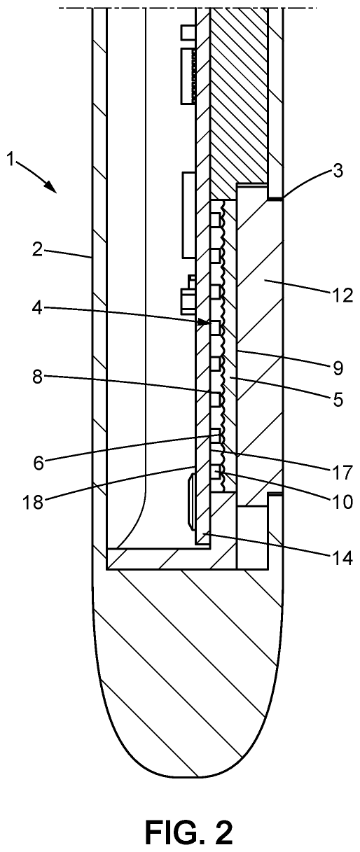

It is now referred to FIGS. 1 and 2. An aerosol generating device 1 is shown comprising a body 2 having a non-opaque window 3, an array 4 of light sources 10 located inside the body 2, a light diffuser 5 disposed between the array 4 of light sources 10 and the non-opaque window 3 and having a first face 6 facing the array 4 of light sources 10 and comprising a pattern 7 of a plurality of dome-shaped recesses 8 and a second face 9 opposed to the first face 6 and directly or indirectly, in this example indirectly, visible through the non-opaque window 3. The aerosol generating device 1 comprises a glass 12 outwardly covering the light diffuser 5 and extending in the non-opaque window 3. This explains that the second face 9 is indirectly visible through the non-opaque window 3 in this example. Such a glass may be absent without departing from the scope of the disclosure. In the latter case, the second face 9 may be directly visible from the non-opaque window.

The body 2 is also housing a printed circuit board 14 (PCB) of the aerosol generating device 1, in a manner known per se. As shown in FIG. 2, the array 4 of light sources 10 is placed on a face 17 of the PCB 14 whereas the other parts of the PCB 14 are placed on the other face 18 of the PCB 14. In this example, the array 4 of light sources 10 is arranged between face 17 of the PCB 14 and the light diffuser 5, in contact with them in this example. In other words, the array 4 of light sources 11 is mounted on the face 17 of the PCB 14 so that the array 4 of light sources 11 faces the light diffuser 5.

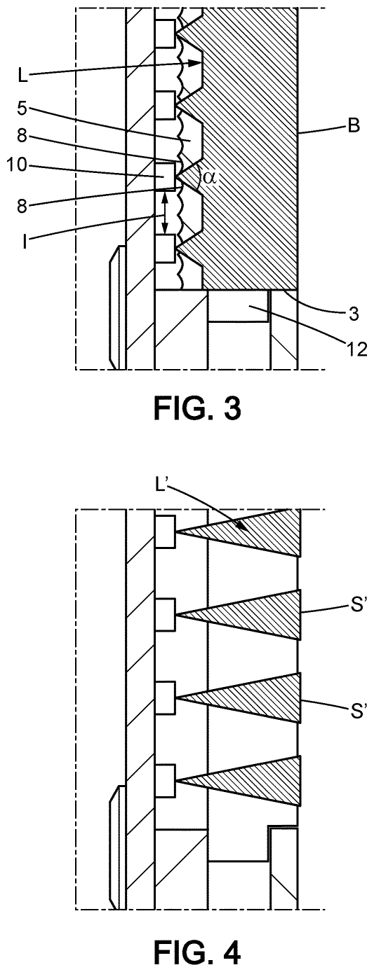

In this example, as shown in particular in FIG. 3 showing the light path L from the light sources 10, the light diffuser 5 is configured so that at least one dome-shaped recess 8, in this example at least two dome-shaped recesses 8, of the plurality of dome-shaped recesses 8 is(are) on the way of a straight path L of light of one, in this example each, light source 10 of the array 4 of light sources 10.

The light diffuser 5 allows the light path L to lead to a continuous and homogeneous bar B visible by a user, as seen in FIGS. 1 and 3. The bar B forms an illuminated status indicator. On the contrary, without a light diffuser, as shown in FIG. 4, the light path L′ leads to a discontinuous and inhomogeneous bar, with distinct light spots S′ visible by the user. FIG. 4 shows a device that is not included in the present disclosure, this device being shown only for comparison with the device shown in FIG. 3.

In the example of FIGS. 1 to 3, the array 4 of light sources 10 is a linear array. The light sources 10 of the array 4 are spaced apart from each other. There is a distance I between two light sources 10 that may be between 1 mm and 6 mm.

Still in this example, the light sources 10 of the array 4 are light emitted diodes (LED).

The emitting angle α of at least one light source 10, in this example of all light sources 10, is equal to 120°.

Thanks to the array 4 of light sources 10, one or several pieces of information may be provided by the aerosol generating device 1 to a user, such as an electrical power consumption, a device health or any other useful information. Of course, the number of light sources 10 that are switched on in the illuminated status indicator depends on the information provided and may in particular be different from the total number of light sources.

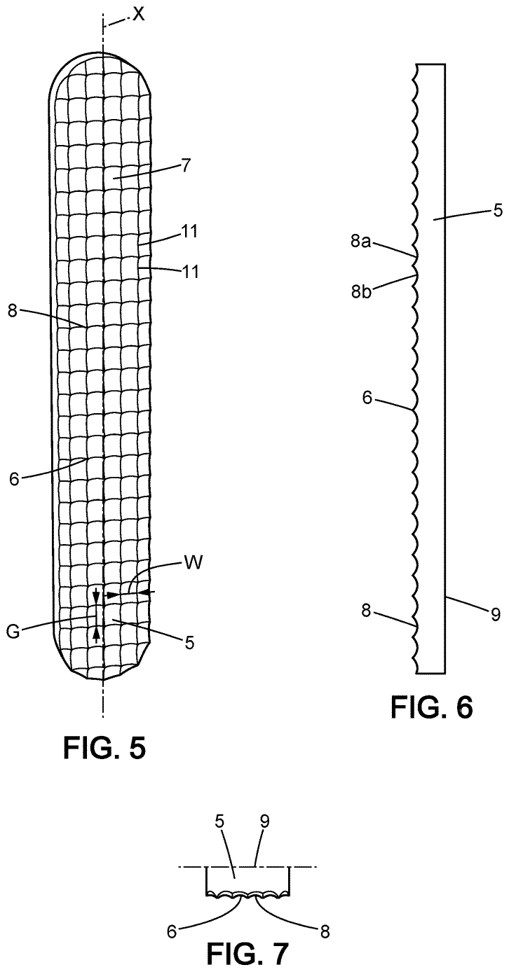

An example of the light diffuser 5 is shown in isolation on FIGS. 5 to 7. As can be seen, at least part of the dome-shaped recesses 8, in this example each dome-shaped recess 8, has a spherical shape. Furthermore, at least part of the dome-shaped recesses 8, in this example all of them are identical to one another.

As can be also seen in these figures, at least two dome-shaped recesses 8, for example numbered 8a and 8b, of the plurality of dome-shaped recesses 8 are side by side in contact with one another, having an edge in common.

Still in this example, the pattern 7 comprises a plurality of parallel ranges 11 of dome-shaped recesses 8, the ranges 11 being oriented perpendicularly to a longitudinal axis X of the non-opaque window 3.

In an example, the light diffuser 5 can comprise thirty-four ranges 11 extending one above the other along the longitudinal axis X, perpendicularly to the latter, each range 11 having six dome-shaped recesses 8. The ranges at the longitudinal ends of the light diffuser 5 may have less than six dome-shaped recesses because of the rounded shape of these ends in an example.

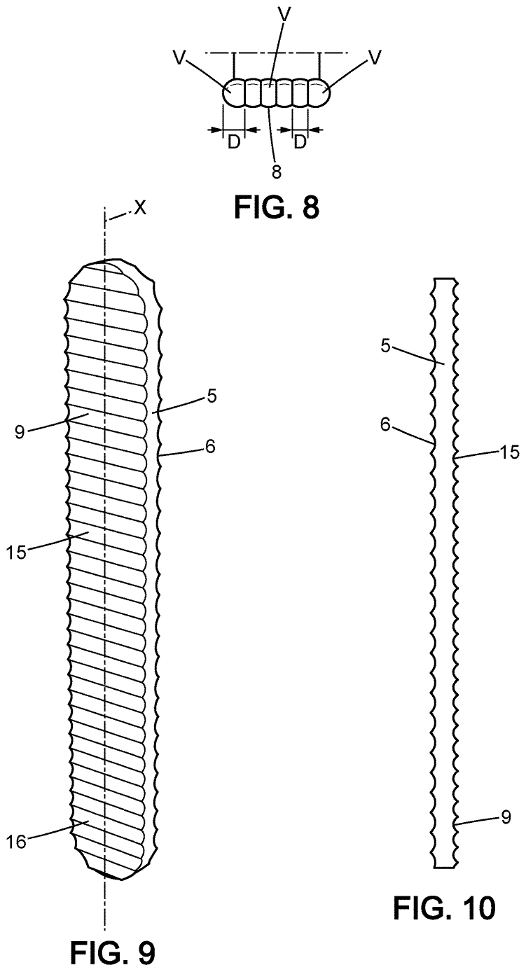

FIG. 8 shows a 3D model created before 3D printing of the light diffuser 5. In this model virtually representing the pattern 7, at least some of the dome-shaped recesses 8 of the pattern 7, preferably each dome-shaped recess 8, is/are part of a virtual sphere V having a diameter D equal to about 1 mm in this example.

The width W of a dome-shaped recess 8, in particular within a range 11, is equal to 0.55 mm in this example. The width W is measured perpendicularly to the longitudinal axis X. The length G of a dome-shaped recess 8, in particular within a range 11, is equal to 0.7 mm. The length G is measured parallel to the longitudinal axis X.

The front peripheral shape of a dome-shaped recess 8, especially within a range 11, having other dome-shaped recesses 8 all around its periphery may be rectangular, as can be seen for example in FIG. 5.

In the example shown in FIGS. 1 to 8, the second face 9 of the light diffuser 5 is substantially flat, notably with no relief thereon.

In the example of FIGS. 9 and 10, the second face 9 of the light diffuser 5 comprises at least one depression 15, notably a plurality of depressions 15, in this example made of a plurality of parallel grooves 16 extending perpendicularly to the longitudinal axis X and concave towards the non-opaque window when introduced within an aerosol generating device.

In the examples of FIGS. 1 to 10, the light diffuser 5 is made of a non-transparent and non-opaque, preferably white, polymer material chosen in the group consisting of a tough PLA and ABS.

The light diffuser 5 with the pattern 7 of dome-shaped recesses 8 may be made by 3D printing in this example, preferably on a high-resolution 3D printer. Furthermore, at least one of the first face 6 and second face 9 of the light diffuser 5 may be sanded. This may result from a surface treatment implemented after the 3D-printing manufacturing process.

After 3D-printing, the light diffuser 5 may be cut so as to have the external suitable shape shown for example on FIGS. 5 and 9, which has two longitudinal parallel edges and, at the upper and bottom ends, rounded edges. This external shape may be the same as the one of the non-opaque window shown in FIG. 1, for example.

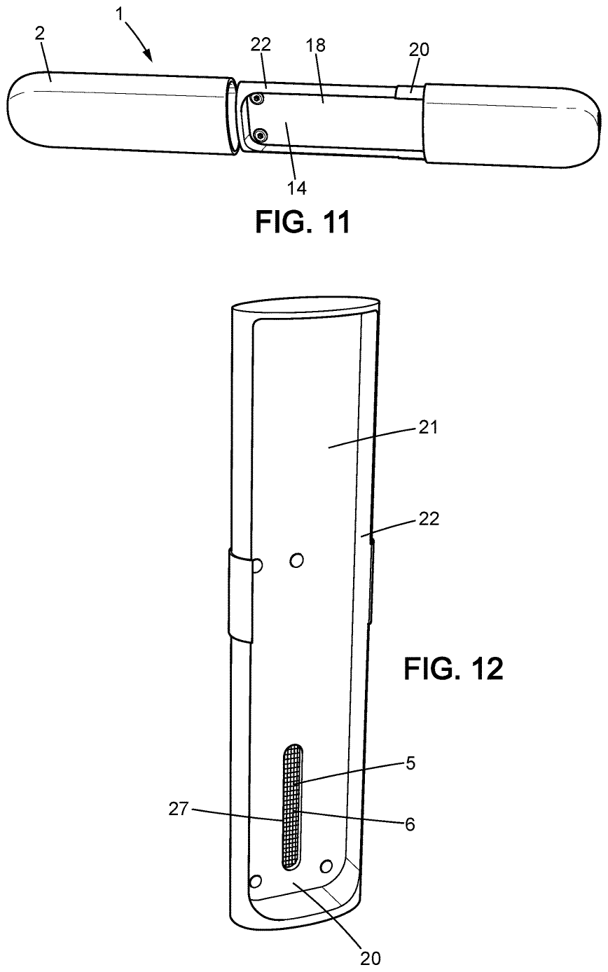

In the example of FIGS. 11 and 12, the light diffuser 5 is inserted into an inner tray 20 of the aerosol generating device 1 between the non-opaque window 3 and the array 4 of light sources 10, the light sources 10 of the array 4 being preferably fixed to the face 17 of the PCB 14 of the device 1. The inner tray 20 is shown in isolation on FIG. 12. It is made to include the light diffuser 5 and to accommodate the PCB 14, the inner tray 20 having a face 21 including an opening 27 for housing the light diffuser 5 and lateral walls 22 extending from the periphery of the face 21 perpendicularly thereof. The lateral walls 22 surround the edges of the PCB 14. The opening 27 has the same shape and dimensions as the light diffuser 5, as shown in FIG. 12, in this example.

Other shapes may be implemented without departing from the scope of the disclosure. The disclosure has been described with reference to preferred embodiments. However, many variations are possible within the scope of the disclosure.

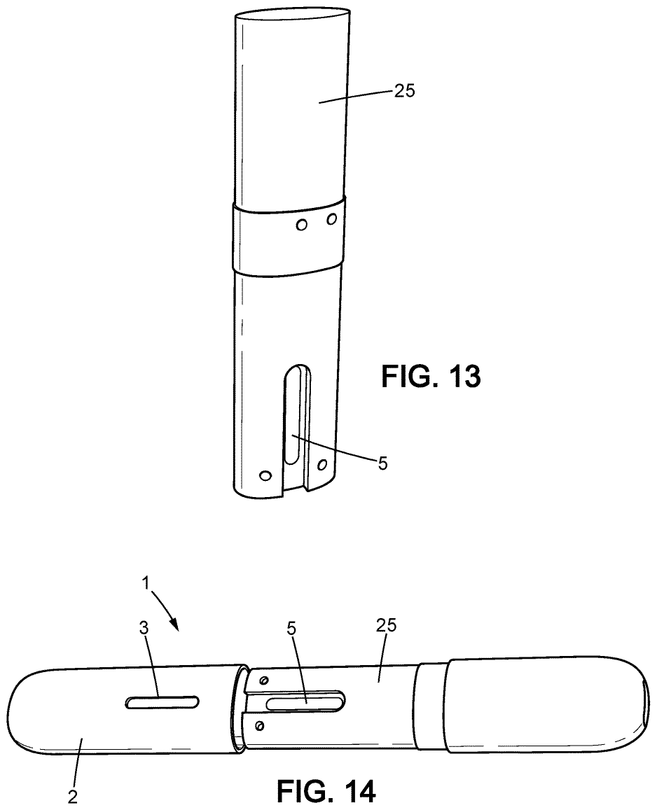

In the example of FIGS. 13 and 14, the light diffuser 5 is part of an inner tray 25 of the aerosol generating device 1. The inner tray 25 internally covers the member parts of the aerosol generating device 1, as shown in FIGS. 13 and 14. In such example, the light diffuser 5 may be made together with the inner tray 25, by 3D-printing, for example.

In order to make the light diffuser 5 for the aerosol generating device 1, it is possible to make a 3D-printing of the light diffuser 5, preferably with a high-resolution 3D printer, from a non-transparent, preferably white, polymer material chosen for example in the group consisting of a tough PLA (polylactic acid), ABS (Acrylonitrile Butadiene Styrene), PA (Polyamide), PMMA (Acryl or Polymethylmethacrylate), PC (Polycarbonate), POM (polyoxymethelen), and ASA (Acrylonitrile styrene acrylate). During the 3D-printing, a plurality of dome-shaped recesses 8 are made in the first face 6 of the light diffuser 5. The 3D-printing may also comprise forming a plurality of depressions in the second face 9, such as the ones shown in FIG. 9. Before 3D printing, a 3D model may be created such as the one of FIG. 8.

The aerosol generating device may be of any type concerning the type of consumable article (with a precursor in a liquid, solid or gel form, comprising tobacco or not, for example), the type of heating unit (either resistive or inductive, for example).

Instead of being 3D printed, the light diffuser may be injection moulded.

1. An aerosol generating device comprising:
a body having a non-opaque window;
an array of light sources located inside the body; and
a light diffuser disposed between the array of light sources and the non-opaque window and comprising:
a first face facing the array of light sources and comprising a pattern of a plurality of dome-shaped recesses; and
a second face opposed to the first face and directly or indirectly visible through the non-opaque window.

2. The aerosol generating device according to claim 1, wherein the light diffuser is configured so that at least one dome-shaped recess of the plurality of dome-shaped recesses is on a way of a straight path of light (L) of one light source of the array of light sources.

3. The aerosol generating device according to claim 1, wherein at least some of the dome-shaped recesses shaped has a spherical shape.

4. The aerosol generating device according to claim 1, wherein at least two dome-shaped recesses of the plurality of dome-shaped recesses are side by side in contact with one another.

5. The aerosol generating device according to claim 1, wherein said pattern comprises a plurality of parallel ranges of dome-shaped recesses, the plurality of ranges being oriented perpendicularly to a longitudinal axis (X) of the non-opaque window.

6. The aerosol generating device according to claim 1, wherein the second face of the light diffuser is substantially flat.

7. The aerosol generating device according to claim 1, wherein the second face of the light diffuser comprises at least one depression extending perpendicularly to a longitudinal axis (X) of the non-opaque window.

8. The aerosol generating device according to claim 1, wherein the light diffuser is made by 3D printing.

9. The aerosol generating device according to claim 1, wherein the light diffuser is inserted into an inner tray of the aerosol generating device between the non-opaque window and the array of light sources.

10. The aerosol generating device according to claim 1, wherein the light diffuser is part of an inner tray of the device.

11. The aerosol generating device according to claim 1, wherein the array of light sources is a linear array, wherein the light sources of the array are spaced apart from each other.

12. The aerosol generating device according to claim 1, wherein the light sources of the array are light emitted diodes (LED).

13. The aerosol generating device according to claim 1, wherein the emitting angle (α) of at least one light source of the array of light sources is equal to 120°.

14. The aerosol generating device according to claim 1, wherein the device comprises a glass outwardly covering the light diffuser and extending in the non-opaque window.

15. A method for making a light diffuser for an aerosol generating device according to claim 1, comprising 3D-printing the light diffuser from a non-transparent, polymer material chosen from the group consisting of a tough PLA, ABS, acrylic glass, the 3D-printing comprising forming a plurality of dome-shaped recesses in the first face of the light diffuser.

16. The aerosol generating device according to claim 9, wherein the light sources of the array are fixed to a printed circuit board of the device.

17. The aerosol generating device according to claim 7, wherein the at least one depression comprises a plurality of depressions made of a plurality of parallel grooves extending perpendicularly to a longitudinal axis (X) of the non-opaque window.

18. The aerosol generating device according to claim 6, wherein the second face of the light diffuser has no relief thereon.

19. The aerosol generating device according to claim 3, wherein at least some of the dome shaped recesses are identical to one another.
